(19) United States
(12) Patent Application Publication
(10) Pub. No.: US 2025/0146712 A1
(43) Pub. Date: May 8, 2025

(54) Any Depth Ground Thermal Battery

(71) Applicants: Richard A. Clemenzi, Asheville, NC (US); Judith A. Siglin, Asheville, NC (US)

(72) Inventors: Richard A. Clemenzi, Asheville, NC (US); Judith A. Siglin, Asheville, NC (US)

(21) Appl. No.: 18/940,830

(22) Filed: Nov. 7, 2024

Related U.S. Application Data
(60) Provisional application No. 63/547,583, filed on Nov. 7, 2023.
(60) Provisional application No. 63/669,599, filed on Jul. 10, 2024.

(51) Int. Cl. F24T 10/10; F28D 20/00; H01M 6/36; H01M 50/24; H01M 50/271; H01M 50/673

(52) U.S. Cl. CPC F24T 10/10; F28D 20/0043; H01M 6/36; H01M 50/24; H01M 50/271; H01M 50/673; H01M 2220/10

(57) ABSTRACT

A highly flexible vertical ground tank system that can be installed to any depth. The principal focus is a hermetically sealed ground thermally conducting tank that can serve as a Ground Coupled Thermal Battery. The intention of this invention is to reduce the cost and/or impact of a Ground Heat Exchanger (GHEX) installation as well as to provide other benefits of building connected Thermal Batteries with heat pumps such as the time shifting of power drawn from the grid for powering the heat pumps, and for utilization of grid energy when cost are reduced to store thermal energy for future use. The same any depth ground installed tank can be used for many purposes.

### CROSS REFERENCE TO RELATED APPLICATIONS

U.S. Provisional Application No. 63/547,590 filed Nov. 7, 2023

U.S. Provisional Application No. 63/669,599 filed Jul. 10, 2024

### PRIOR ART

U.S. Pat. No. 3,638,433 Sherard 1972 Method and Apparatus for Forming Structures in the Ground

US20120152488 A1 Underground Thermal Battery System

U.S. Pat. No. 11,927,368 Shang et al. 2024 Prefabricated Energy Pile, Construction Method, and Heat Pump Heat Exchange System

U.S. Pat. No. 10,767,935 Gergan 2020 Heat Exchanger Comprising Concrete Thermal Energy Storage Elements

U.S. Pat. No. 9,897,347 Breidenbach 2018 Screw-In Geothermal Heat Exchanger Systems and Methods

U.S. Pat. No. 8,132,631 Roussy 2012 Method of Geothermal Loop Installation

### BACKGROUND OF THE INVENTION

The installation of full or hybrid geothermal heat pump (GHP) systems requires the installation of ground heat exchangers (GHEX) into the ground where thermal energy is either extracted or rejected. This installation is mainly done by boring or trenching and installing a fluid loop connected to the heat pump system, and almost always involves very large drilling equipment, significant noise, and significant site impact producing the need for post boring site recovery. Others have considered “buried” tanks which are always relatively shallow and have limited ground coupling, and which again cause significant site impact and the need for site recovery. These negative factors sometimes have significant impact on the selection or not of GHP for heating and cooling even though it is always the most cost effective approach.

More recently awareness has risen of the benefits of storing thermal energy in fluid and/or phase change materials (PCM) in tanks both above ground and below ground. Yet to date, there have been no efforts at commercializing these advances as a specific Thermal Battery beyond “buried” tanks disrupting the surface and trial installations using auger drills with limited depth. The auger approach will work for short bores in sufficiently dry ground that will not collapse before a cylindrical container of some sort can be installed. But that approach has significant depth and site limitations, and will not work at all in many soil types which are not as stable such as sand, wet clay, etc. Other efforts have led to inclusion of a limited amount of PCM in small bore inclusions in thermal piles (structural piles that include thermal exchange loops). All these approaches have significant drawbacks and cannot provide arbitrary depth thermal batteries in any soil type.

### SUMMARY OF THE INVENTION

This invention presents a highly flexible way to install a vertical ground tank to any depth in any soil type significantly increasing the ground coupling surface area involved that can serve as a Ground Coupled Thermal Battery with minimal site impact. The intention of this invention is to reduce the cost and impact of a bored GHEX installation as well as to provide other benefits of building connected Thermal Batteries with heat pumps such as the time shifting of power drawn from the grid for powering the heat pumps, and for utilization of grid energy when grid costs are reduced to store thermal energy for future use.

The invention is to enable a field assembled, any depth, any soil type, vertical cylindrical tank installation for use as a Ground Coupled Thermal Battery. It can serve other tank functions as well.

The invention employs a segmented, vertically installed, hermetically sealed tank suitable for use with any internal thermal battery or thermal storage approach. Described is the complete system required including hermetically sealed tank casing sections, casing section fusion welding to ensure hermetic seal, required installation apparatus, and extensions of the same for further benefits to GHP systems.

The elements of the system include: 1) sections of the vertical tank casing formed as a combination of a rigid material sufficient to withstand crushing pressure at the desired thermal battery installation depth together with sufficient hermetic sealing if not provided by the rigid material, 2) a cutting head sufficient to bore and enable removal or displacement of material ahead of the tank as it is installed, 3) the power apparatus and delivery and control means needed to operate the cutting head and cuttings removal, 4) a coupling system for hermetically connecting the sections of the vertical tank casing, 5) an optional hermetically sealing bottom cap installable after casing installation (if poured sealing material such as concrete is not used), 6) a top hermetically sealing cap which incorporates the pipes and sensors needed to connect the thermal battery with the heat pump system, and 7) installation apparatus necessary for handling, aligning, and facilitating coupling the vertical tank casing sections.

### BRIEF DESCRIPTION OF DRAWINGS

FIG. 1—Overall system sectional depiction

FIG. 2—Tank, Sections, and Cutting Head Overview

FIG. 3—Tank Direct Formed Casing System Elements and Flow

FIG. 4—Birdseye Section of Installed Thermal Battery

FIG. 5—Cutting Head Detail—Frame Version, Overhead View

FIG. 6—Cutting Head Detail—Frame Version, Section, Retracted for Insertion and Removal

FIG. 7—Section of Tank Direct Formed Thermal Battery with PE Walls

FIG. 8—Section of Tank Direct Formed Thermal Battery with Coupling

FIG. 9—Tank with Multi-part Fusion Coupling

FIG. 10—Thermal Tank and Ground Coupling Flow Option

FIG. 11—Thermal Tank Top and Capping Detail

FIG. 12—Thermal Tank Top and Capping Detail—Pass-Through and Thermal Protection

FIG. 13—Cutting Head Detail—Chain version

FIG. 14—Cutting Head Detail—Chain version Retracted for Removal

FIG. 15—Complete Thermal Battery with PCM insertions

FIG. 16—Vertical Multiple Directional Bore Distribution Vault

### DETAILED DESCRIPTION OF THE INVENTION

The present invention involves A) the thermal battery tank body, B) the installation equipment required for assembling and installing the tank body, and C) new elements required to assemble the tank body that may also serve other purposes. At it's root, the invention is all the elements needed to incrementally field assemble and install, one segment at a time, a hermetically sealed tank.

Throughout we refer to a thermal battery tank or thermal battery or tank by itself interchangeably with all three referring to the same ground installed tank. The innovation can install an underground tank for any purpose and all such purposes are implicitly claimed as well. The innovation was conceived in the geothermal heat pump field hence the term thermal battery, but as a basic hermetically sealed underground tank it is applicable to a multitude of applications.

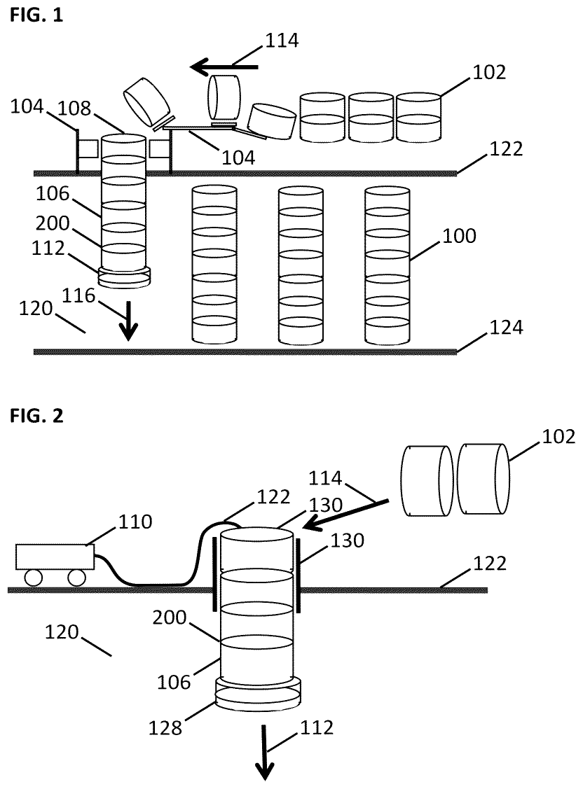

FIG. 1 depicts one embodiment of a thermal battery system being claimed at the macro level showing an example installation where 3 thermal batteries 100 are already installed in the ground 120 below ground level 122 extending to a depth above bedrock 124 with a new thermal battery being installed 106 with couplings 200 between the new sections 102 which are continuously moved 114 via assembly apparatus 104 into position 108 for connection to the thermal battery being installed 106 using the assembly apparatus 104 and connecting elements 200. Also shown is the cutting head 112 which advanced the being installed thermal battery 106 in a downward direction 116.

FIG. 2 depicts one embodiment of a thermal battery system being claimed during installation into the ground 120 where a system power and debris/“mud” processing unit(s) 110 is shown connected by an umbilical 122 to a cutting head 128 through the thermal battery being installed 106 to power the bore and advance tank sections downward 112 guided by an alignment device 130 where the next section being added 108 before they reach the alignment frame 130 pass through the ground level 122. Additional tank sections are in waiting 102.

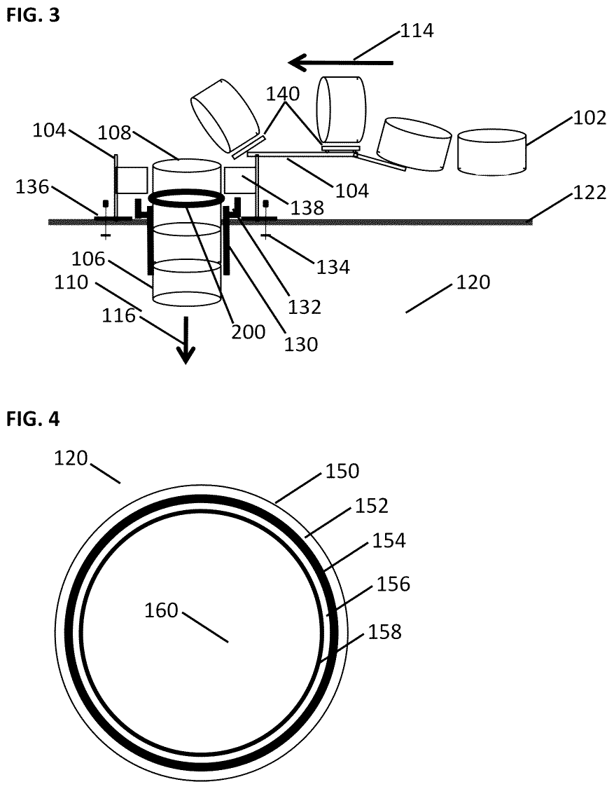

FIG. 3 depicts one embodiment of a thermal battery system being claimed during installation showing a new thermal battery being installed into the ground 120 beginning with new sections 102 which are continuously moved 114 via assembly apparatus 104 into assembly position 108 for connection to the being installed thermal battery 106 using the assembly apparatus 104 which seen here in more detail has new section handling elements 140, next section alignment apparatus 138, feet 136 with ground anchors 134 to enable a reduced weight installation apparatus 104 which also installs an alignment frame into the ground 130 with a grout containment trough 132 to ensure a clean site that does not need extensive recovery after thermal battery installation. Connecting the thermal battery sections is a coupling 104 shown enhanced where the next section in assembly position 108 is being connected to the thermal battery being installed 106. The cutting head is not shown in this figure but is at the bottom of the thermal battery being installed 106.

FIG. 4 depicts one embodiment of a thermal battery system being claimed where a casing section installed into the ground 120 with the outermost cut ground boundary 150 being thermally connected to the thermal battery with a rigid casing 154 a with a typical thermally conductive grout filling a void 152 between the thermal battery tank wall and the ground, with an optional inner grout zone 156 that is present only if an inner hermetic tank is installed after the casing installation, followed inward by the hermetic tank wall 158 which typical embodiments is bonded directly to the rigid casing 154 and which contains the thermal battery contents 160. Also present may be a hermetic layer on the outside of the rigid casing (154) which is optional.

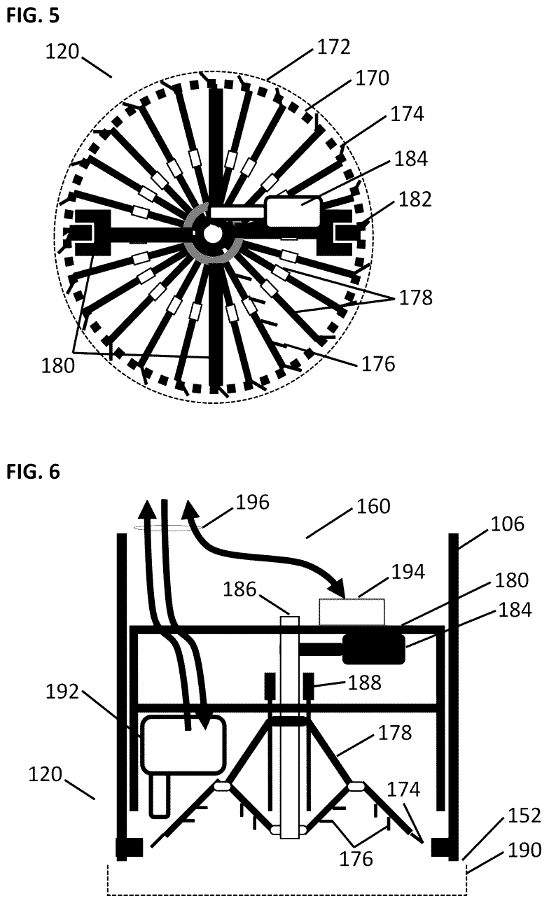

FIG. 5 depicts one embodiment of a cutting head from overhead, this one a rigid frame version, showing the above tank casing section 170 (thick dashed line) and the outer cutting boundary 172 (thin dashed line) where the head has dug into the ground 120 using cutting teeth 174 and 176 (shown on one cutting arm only) mounted to retractable arms with retraction pivots 178. The whole cutting head is mounted to a frame 180 locked onto stops in the bottom casing section 182 and driven by a cutting drive motor 184 with the frame anchored.

FIG. 6 depicts one embodiment of a cutting head in more detail in retracted mode while being removed where the installed thermal battery 106 is being installed into the ground 120 with the cutting head mounted to a frame 180 with cutting drive motor 184 that turns a rotating shaft 186 where the retractable arms 178 are mounted with cutting teeth 174 and 176, with retraction motors 188 which cause the retractable arms with retraction pivots 178 to pull back from the already cut area 190 which is slightly larger than the casing section 106 to ensure friction free installation. Debris removal from the cutting operation is handled by a debris pump 192 which sends debris and may receive clean replacement grout mix that fills the thermal battery inside 160 during installation and the void 152 between the thermal battery tank wall and the ground with a slurry mix through a utilities tubing bundle 196 which also connects the electronics control 194 with the surface where the electronics control all motors in the system and provide sensor feedback.

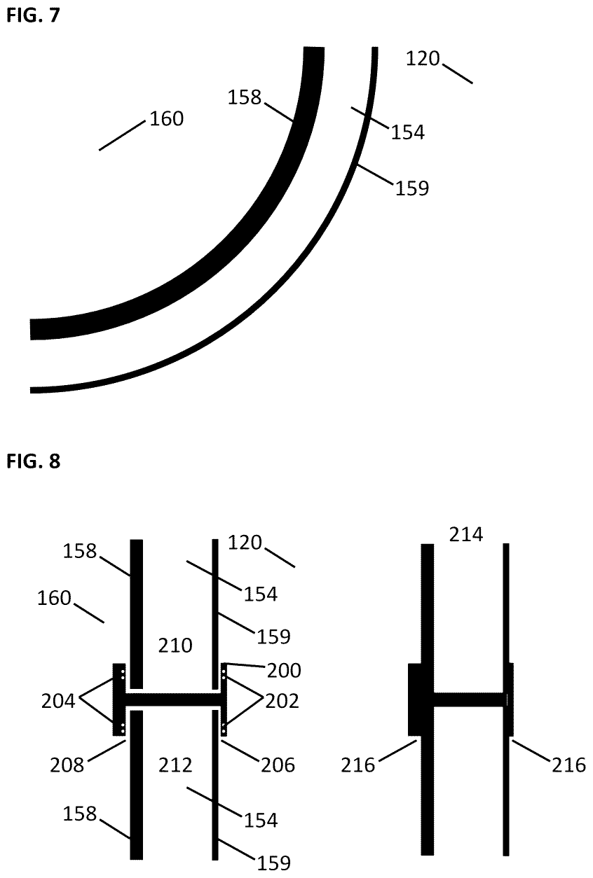

FIG. 7 depicts one embodiment of a thermal battery tank wall section installed into the ground 120 surrounding a tank inside area 160 where the rigid part of the casing 154 has an inner hermetic tank wall 158 and here an outer hermetic tank wall 159 with the rigid inner part formed directly to the inner and outer hermetic walls. In many embodiments, the inner and outer tank walls will be HDPE although other materials capable of creating a hermetic seal including being reliably bonded to the adjoining tank sections. The rigid part of the tank wall casing in many embodiments could be concrete although any other structurally sound material capable of avoiding collapse of the thermal battery tank could be used, including HDPE.

FIG. 8 depicts one embodiment of a thermal battery tank element a coupling connects the tank upper 210 and lower 212 tank sections with inner hermetic tank walls 158 and an outer hermetic tank walls 159 containing inside area 160 with rigid parts 154 using a double sided electrofusion connector 200 (cross section shape of an “H”) with internal electric resistive heating elements in both the outside 202 and inside 204 parts of the connector 200 where outer gap 206 and inner gap 206 (shown exaggerated here while in real life there is no space between the elements being connected and an electrofusion connector) which gaps are both completely eliminated by the electrofusion process of melting the coupling and inner and outer hermetic walls into one continuous piece of hermetic material (normal fusion process). The repeat figure at right 214 shows the resulting hermetically fused sections with no gaps remaining 216.

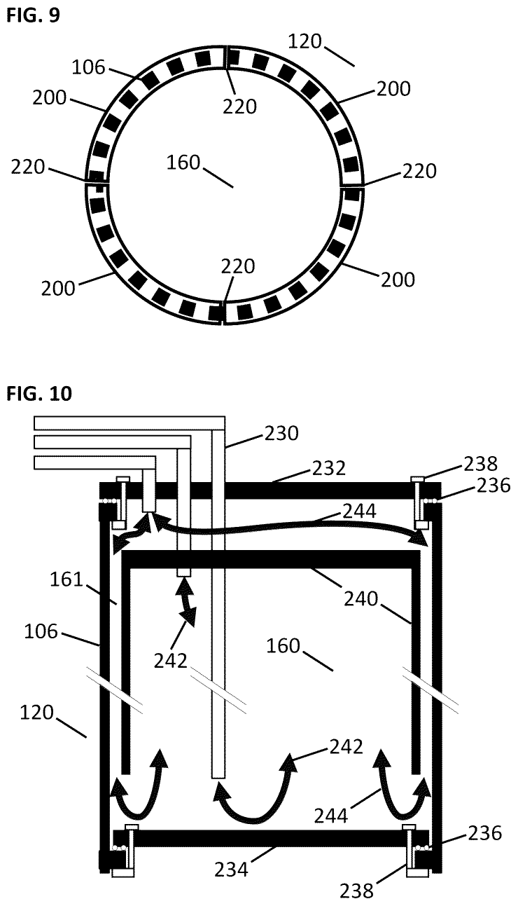

FIG. 9 depicts one embodiment cross section of a coupled thermal battery tank at the section coupling where here four (4) fusion couplings 200 connect thermal battery tank elements 106 (full circle, large dashed to see the couplings) to hermetically seal the inner tank area 160 from the surrounding ground 120. As the tank sections may be large and transport of such large couplings may not be practical, these couplings 200 have end electrofusion built in as well at the meeting points 220 (4 places) to ensure a full hermetic seal once fused. This same coupling is applicable to any large diameter HDPE and other thermo fusion bonded pipe.

FIG. 10 depicts one embodiment of a completed thermal tank 106 fully installed in the ground 120 with a lid 232 and bottom 234 both sealed to the tank casing with sealing o-rings 236 and latches 238 and with thermal fluid flows depicted by arrows 242 to an inner area 160. In some embodiments an inner baffle 240 enabling separate thermal fluid flows 244 to an outer tank area 161 depicted adjacent to the ground and separately to an inner area 160. In the configuration with an inner baffle 240, three (3) incoming pipes 230 are used to enable the separate fluid flow directions. Note that only 2 pipes are required if the inner isolation barrier 240 is not thus enabling flow to the top or bottom of the tank.

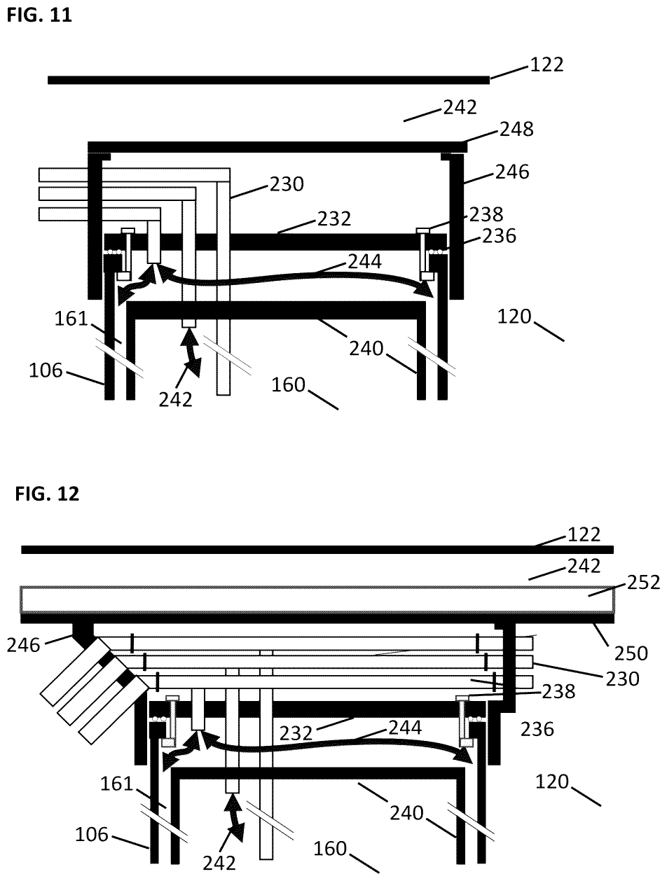

FIG. 11 depicts one embodiment of a completed thermal tank 106 fully installed in the ground 120 below ground level 122 with an area above the tank refilled with earth 242 with a lid tank 232 sealed to the tank casing with sealing o-rings 236 and latches 238 and with thermal fluid flows depicted by arrows 242 to an inner area 160, and when an optional inner baffle 240 is added enabling separate thermal fluid flows 244 to an outer tank area 161 adjacent to the ground as well as to an inner area 160. In the configuration with an inner baffle 240, three (3) incoming pipes 230 are used to enable the separate fluid flow directions, with only 2 pipes are required if the inner isolation barrier 240 is not thus enabling flow to the top or bottom of the tank. In the embodiment shown, an outer enclosure 246 and lid 248 are included to keep the tank lid 232 free of soil or debris.

FIG. 12 depicts one embodiment of a completed thermal tank 106 fully installed in the ground 120 below ground level 122 with an area above the tank refilled with earth ground cover 242 here with an insulation layer 252, with a lid tank 232 sealed to the tank casing with sealing o-rings 236 and latches 238 and with thermal fluid flows depicted by arrows 242 to an inner area 160, and optionally by 244 when an optional inner baffle 240 is added enabling separate thermal fluid flows 244 to an outer tank area 161 adjacent to the ground as well as to an inner area 160. In the configuration with an inner baffle 240, three (3) incoming pipes 230 are used to enable the separate fluid flow directions, with only 2 pipes required if the inner isolation barrier 240 is not installed thus enabling flow only to the top or bottom of the tank. In the embodiment shown, an outer enclosure 246 and larger lid 250 are included to keep the tank lid 232 free of soil or debris, with here the pipes continuing through for connection to adjacent thermal batteries, and here with an added insulation layer 252 to protect from outdoor thermal influence and to allow shallow placement for ready access. The ground cover 242 is not required a valve box is placed over the tank for instant access.

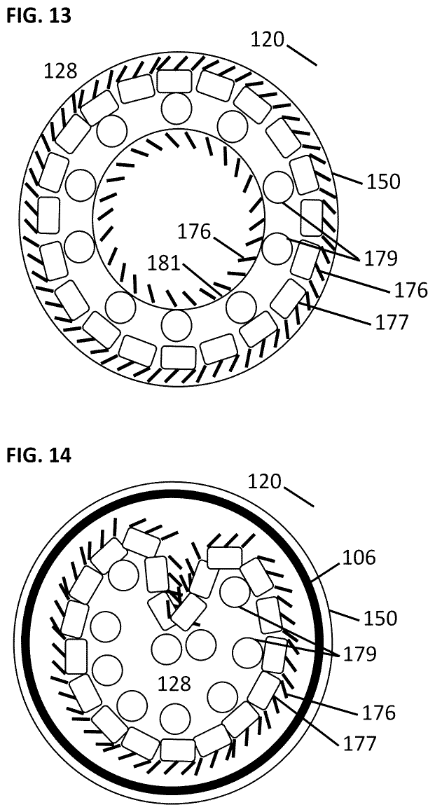

FIG. 13 depicts one embodiment of a cutting head 128 with outer and bottom cutting teeth 176 attached to chain sections 177 which roll on sprockets 179 and cutting to an outer diameter 150 in the ground 120. The bottom cutting teeth are connected to an inner bottom head 181 lowered into cutting position after the chain sprockets are expanded on insertion. Not shown is the collapsing frame holding the sprockets or the motor driving the sprockets.

FIG. 14 depicts one embodiment of a cutting head 128 here retracted within the thermal battery tank wall 106 for removal with bottom head and teeth retracted above this section view (not shown) and with the cutting teeth 176 attached to chain sections 177 pulled inward with their sprockets 179 away from the outer cut diameter 150 in the ground 120. Not shown is the collapsing frame holding the sprockets or the motor driving the sprockets.

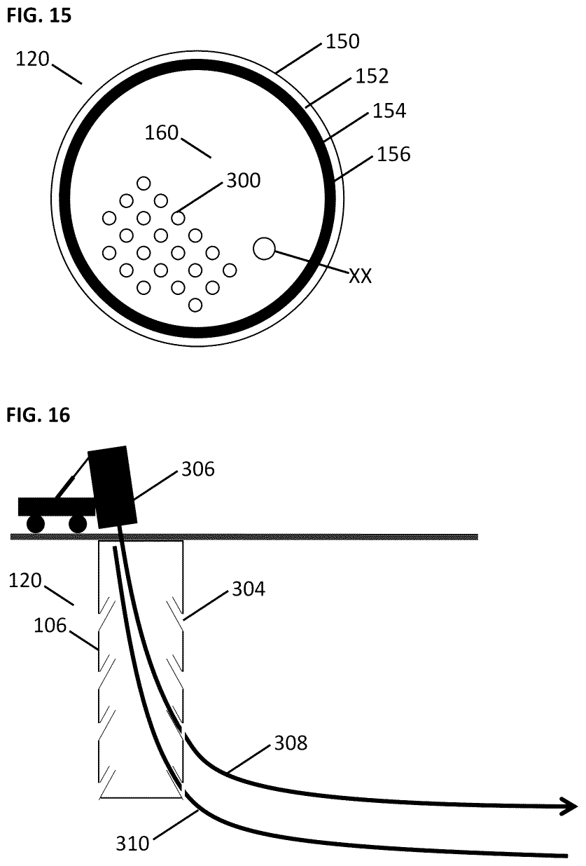

FIG. 15 depicts one embodiment of a thermal battery system being claimed where a casing section installed into the ground 120 with the outermost cut ground boundary 150 being thermally connected to the tank with a rigid casing 154 with a typical thermally conductive grout filling a void 152 between the thermal battery hermetic tank wall and the ground, where in some embodiments the thermal battery contents 160 include sealed inserts 300 containing thermal energy storage substance such as PCM (showing only a portion of the inserts that would be used for visual clarity) and with at this horizontal section cutting point a pipe 260 that extends to the bottom of the tank to enable working fluid up or down the tank.

FIG. 16 depicts one embodiment of an alternate use of a vertical ground tank installation below ground 120 where the tank walls 302 contain built in angled penetrations 304 where such that a boring device 306 such as a typical horizontal boring machine but used at a higher degree of inclination to install a collection of effectively horizontal bored ground loops being installed 308 and already installed 310 through the angled penetrations 304 to provide a way to effectively utilize deep overburden soils for thermal gain with precision horizontal bore placement at depth. These same penetrations or a variation thereon could also serve as a monitoring well with access to multiple levels of ground instead of just one level.

Further embodiments and specific applications using the same any depth ground tank installation approach are envisioned and claimed.

1. An apparatus being a multi-segment, hermetically sealed, vertically installed ground tank (the tank) that can be installed to any depth without risk of ground or tank contamination, said apparatus comprising:
rigid tubular segments;
couplings to hermetically connect the rigid tubular segments;
a hermetically sealing top; and
an optional hermetically sealing bottom;
where
the rigid tubular segments provide protection from collapse and a hermetical seal from the ground and can be hermetically sealed to adjoining segments;
the couplings form a hermetic seal between the rigid tubular segments;
the rigid tubular segments and couplings are installed in alternating sequence to form the walls of the tank;
the optional hermetically sealing bottom can be used to seal the bottom of the tank; and
the hermetically sealing top allows for fluid pipe and sensor connections to the tank.

2. The apparatus in claim 1 where the tank can serve as a Ground Coupled Thermal Battery.

3. The apparatus in claim 1 where the hermetically sealing top is removable.

4. The apparatus in claim 1 where the tank's hermetic sealing is via a fusion bondable surface material such as HDPE.

5. The apparatus in claim 4 where the couplings are electrofusion couplings able to bond with the tank's hermetic sealing fusion bondable surface material.

6. The apparatus in claim 5 where the couplings are multi-part with electrofusion at each end to also fusion bond the segments together into one coupling during fusion bonding.

7. The apparatus in claim 1 where the tank has an inner barrier and 3 pipes conveying fluid to support all of to tank only, to tank first, to ground coupled wall first, from tank, and from ground coupled wall fluid paths.

8. An apparatus and supporting elements for installation of a multi-segment, large diameter, hermetically sealed, vertically installed ground tank (the tank), said apparatus comprising:
a next segment supply element;
an alignment element;
a feeding element;
a power supply element;
a control element;
a non-mechanically connected cutting head;
a control element;
a cutting head removal element; and
an optional bottom installation element;
where
the next segment supply element can lift and position large diameter tank segments;
the alignment element can align, hold, and lower a next segment for coupling onto already installed segments;
the a non-mechanically connected cutting head is powered by the power supply element via an umbilical; and
the feeding element can allow the controlled descent of the assembled segments into the ground.

9. The apparatus in claim 8 where the non-mechanically connected cutting head can retract and expand on command from the control element for installation and removal with the cutting head removal element.

10. The apparatus in claim 8 where the an optional bottom installation element is a robotic device capable of aligning and sealing the optional bottom to the bottom segment of the tank.

11. An apparatus being a split electrofusion coupling for hermetically sealing segmented large diameter elements into a continuous hermetically sealed unit; where
the large diameter elements are at least 1 foot in diameter.

12. The apparatus in claim 11 where the couplings are multi-part with electrofusion at each end to also fusion bond the segments together into one coupling during fusion bonding the large diameter elements.

13. The apparatus in claim 11 where the couplings bond both the inner and outer walls of the large diameter elements.
